(19) United States
(12) Patent Application Publication
(10) Pub. No.: US 2016/0273477 A1
(43) Pub. Date: Sep. 22, 2016

(54) METHOD FOR PRODUCING A SPRAYED CYLINDER RUNNING SURFACE OF A CYLINDER CRANKCASE OF AN INTERNAL COMBUSTION ENGINE AND SUCH A CYLINDER CRANKCASE

(71) Applicant: KS HUAYU Alu Tech GmbH, Neckarsulm (DE)

(72) Inventors: LEANDER SCHRAMM, REMDA-TEICHEL (DE); CHRISTIAN KLIMESCH, KARLSRUHE (DE)

(73) Assignee: KS HUAYU ALUTECH GMBH, NECKARSULM (DE)

(21) Appl. No.: 15/037,327

(22) PCT Filed: Aug. 12, 2014
(86) PCT No.: PCT/EP2014/067246

§ 371 Date: May 18, 2016

(30) Foreign Application Priority Data
Nov. 20, 2013 (DE) 10 2013 112 809.2

(51) Int. Cl. F02F 1/00; C23C 4/131; C23C 4/06; C23C 4/134

(52) U.S. Cl. CPC F02F 1/004; C23C 4/134; C23C 4/131; C23C 4/06; F02F 2001/008

(57) ABSTRACT

A method for producing a cylinder running surface of a cylinder crankcase of an internal combustion engine includes thermally spraying a coating material comprising particles onto a cylinder inner wall of a cast cylinder crankcase using an inert gas as an atomizer gas so as to produce a coating. A mass feed rate of the coating material during the thermal spraying is 8 to 22.5 kg/h.

### CROSS REFERENCE TO PRIOR APPLICATIONS

This application is a U.S. National Phase application under 35 U.S.C. §371 of International Application No. PCT/EP2014/067246, filed on Aug. 12, 2014 and which claims benefit to German Patent Application No. 10 2013 112 809.2, filed on Nov. 20, 2013. The International Application was published in German on May 28, 2015 as WO 2015/074775 A1 under PCT Article 21(2).

### FIELD

The present invention relates to a method for producing a cylinder running surface of a cylinder crankcase of an internal combustion engine, wherein a coating at a cylinder inner wall of a cast cylinder crankcase is produced by thermal spraying, and wherein an inert gas is used as an atomizer gas. The present invention also relates to a cylinder crankcase for an internal combustion engine having a cylinder running surface which is produced by the above method by thermal spraying of the cylinder inner wall.

### BACKGROUND

Various methods for applying a coating serving as a cylinder running surface by means of thermal spraying of the cylinder inner wall of a cylinder crankcase have previously been described. In particular plasma spraying and arc spraying are used as spraying methods to produce cylinder running surfaces. In the case of arc spraying, an arc is struck between two wire-shaped spraying materials, which arc causes the wire tips to melt at a temperature of approximately 4000° C. and to be sprayed by atomization onto the prepared workpiece surface. In the case of plasma spraying, in a burner, an anode and at least one cathode are separated from each other via a small gap, and an arc is generated between the anode and the cathode by applying a direct-current voltage. A gas flows through the burner, which gas is directed through the arc and is thereby ionized to produce a highly heated electrically conductive gas which serves as a plasma flow into which a powder with a grain size of 5-120 μm is injected that melts due to the high plasma temperature. The plasma flow entrains the powder particles and accelerates the fully or partly molten particles of the coating material towards the cylinder inner wall to be coated.

DE 697 02 576 T1 describes a method for coating cylinder inner walls by thermal spraying, wherein first an air flow spin-coats the cylinder inner walls with the molten powder or the molten wire of a low-carbon steel having a carbon content of less than 0.3% or of a high-grade steel, whereby a lower layer having a high oxide content is produced. Such a layer is very hard. Another layer is subsequently applied, wherein an inert gas serves as the atomizer gas so that the oxide content in the layer is considerably reduced. This softer layer is then removed to produce a surface having a desired surface quality so that the hard wear-resistant lower layer remains as the running surface.

DE 199 34 991 A1 describes a plasma spraying method, wherein nitrogen is used as the atomizer gas during the production of cylinder running surfaces. A second nitrogen gas flow accompanying the atomizer gas flow is employed so that no vacuum chamber is required. The oxide content of the coating is thereby adjusted.

These coatings are, however, problematic because corrosion arises, which corrosion proceeds rapidly in layers having a high oxide content, and more slowly in layers having a low oxide content. The corrosion results in an increased wear of the cylinder running surface. The described methods for thermal spraying are also very expensive since high-grade steels or at least low-carbon steels are used to prevent corrosion.

### SUMMARY

An aspect of the present invention is to provide a method for producing a sprayed cylinder running surface of a cylinder crankcase of an internal combustion engine, and a cylinder crankcase, wherein the cylinder running surfaces have a high corrosion resistance even when low-alloy carbon-containing steels are used, which have a high durability, and an inexpensive method of production.

In an embodiment, the present invention provides a method for producing a cylinder running surface of a cylinder crankcase of an internal combustion engine which includes thermally spraying a coating material comprising particles onto a cylinder inner wall of a cast cylinder crankcase using an inert gas as an atomizer gas so as to produce a coating. A mass feed rate of the coating material during the thermal spraying is 8 to 22.5 kg/h. In an embodiment, the present invention also provides a cylinder crankcase for an internal combustion engine comprising a cylinder running surface produced by a method comprising thermally spraying a coating material comprising particles onto a cylinder inner wall of a cast cylinder crankcase using an inert gas as an atomizer gas so as to produce a coating. A mass feed rate of the coating material during the thermal spraying is 8 to 22.5 kg/h. The coating has a layer porosity of 4.5 to 25%, and an oxide content of 0.5 to 5%.

### BRIEF DESCRIPTION OF THE DRAWINGS

The present invention is described in greater detail below on the basis of embodiments and of the drawing in which:

FIG. 1 shows a diagrammatic illustration of a nozzle of a PTWA or RWS burner as well as the structure of the coating produced at the cylinder inner wall.

### DETAILED DESCRIPTION

Because thermal spraying has a mass feed rate of the coating material of 8 to 22.5 kg/h, instead of 4 to 7 kg/h as has so far been usual, the particle velocity is reduced, while the particle size in the coating is increased. A cylinder crankcase for an internal combustion engine can thus be manufactured according to the present invention wherein the sprayed-on coating has a layer porosity of 4.5 to 25% and an oxide content of 0.5 to 5%. The low oxide content, which is also attained due to the use of the inert gas, results in a low wustite phase, whereby the oxidation rate of the layer is considerably decreased, so that corrosion is reduced. A larger open-pore portion is also created, whereby a larger oil retaining volume at the cylinder running surface is produced which also results in a higher corrosion resistance at the surface of the layer. The use of the inert gas additionally prevents an exothermal reaction at the particle surface during which, where case carbon-containing coating materials are used, the carbon of the wire would be burned. The oxidation and the particle temperature are thus reduced.

In an embodiment of the present invention, the atomizer gas feed rate during thermal spraying can, for example, be 900 to 1,500 l/min. This gas feed rate allows corrosion-resistant protective layers to be produced in a simple manner which have a high porosity.

In an embodiment of the present invention, the atomizer gas feed rate during thermal spraying can, for example, be reduced to 300 to 900 l/min. This results in the velocity and the temperature of the coating material at the nozzle being further reduced so that less energy is transferred to the particles of the coating material. The effect attained by the increase in the mass feed rate is thus further enhanced so that an even higher porosity is attained.

In an embodiment of the present invention, nitrogen or argon can, for example, be used as the inert gas. These gases allow for low-oxide layers to be produced in an inexpensive manner.

In an embodiment of the present invention, a low-alloy carbon steel can, for example, be used as the coating material since this steel can be produced at considerably lower costs. The particular selected method parameters prevent a premature burn-off of the carbon with premature oxidation so that an adequate corrosion resistance is nevertheless attained. These steels are easy to process and they produce the martensite required to attain the necessary hardness of the layer during spraying.

In an embodiment of the present invention, the coating can, for example, be produced via a plasma spraying or an arc spraying, in particular via a plasma transferred wire arc spraying (PTWA spraying) or via a rotating single wire spraying (RSW spraying). These methods are in particular suitable for producing porous low-oxide layers.

In an embodiment of the present invention, an argon-hydrogen mixture or an argon-nitrogen mixture can, for example, be used as the plasma gas, wherein, when an argon-hydrogen mixture is used, the hydrogen content of the plasma gas is 5 to 40%. The desired layer porosity as well as the desired oxide content are reliably attained with these method parameters.

In an embodiment of the present invention, the particle surface temperature can, for example, be 1,600 to 2,400° C., the arc temperature can, for example, be 3,000 to 6,000° C., and the plasma gas temperature can, for example, be 10,000 to 15,000° C. Particles which are not completely molten occur at the surface with only a small amount of oxide inclusions.

In an embodiment of the present invention, the plasma gas feed rate can, for example, be 40 to 250 l/min so that a relatively low velocity of the particles at relatively low particle temperatures continues to be attained.

In an embodiment of the present invention, the coating can, for example, be honed after the spraying process to produce the cylinder running surface. Additional pores of the sprayed layer, which act as micro pressure chambers and in which oil can be collected, are thereby exposed, and a functional honed surface is created. Axially symmetrical constant wall thicknesses can also be produced.

A method for producing a cylinder running surface of a cylinder crankcase and a thus produced cylinder crankcase having a high corrosion resistance are therefore provided. The supply of the running surfaces with oil is provided so that a long service life of the coating is attained. The costs for producing the coating are reduced compared with other conventional methods, in particular when carbon-containing low-alloy steels are used as coating materials.

The method is hereafter described on the basis of a coating applied by a PTWA burner or a RSW burner, and the thus produced cylinder running surface, under reference to the drawing.

A cylinder crankcase having one or a plurality of cylinders is first cast in a conventional manner in an aluminum casting process. Since the cylinder inner walls of the cylinder crankcase often do not comprise an adequately durable cylinder running surface, such a surface is produced by first activating the cylinder inner wall by producing, for example, undercut structures. A coating is then applied to the cylinder inner walls via a thermal spraying. For this purpose, in the present embodiment, a PTWA or an RSW burner 10 is inserted into the cylinder and axially and rotationally moved to apply the layer.

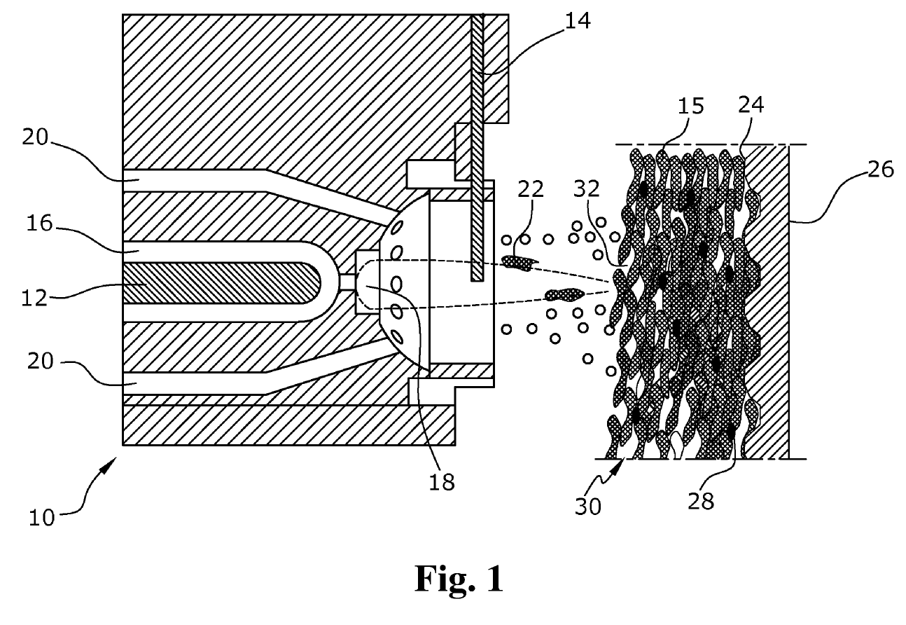

FIG. 1 shows a cylinder inner wall onto which a thermally sprayed layer is applied via burner 10.

The burner 10 shown in FIG. 1 comprises a first electrode 12 connected to a first voltage source as well as a conductive wire 14 acting as a second electrode made of a low-alloy carbon-containing steel which is connected to the opposite pole of the voltage source, is vertically supplied, and which acts as a coating material 15. The first electrode 12 is surrounded by bores 16 of the burner 10, the position of bores 16 producing a gas flow possibly showing a swirl along the first electrode 12 and escaping at a high velocity through a nozzle 18. The plasma gas is composed of an argon-hydrogen mixture having a hydrogen content of approximately 25%.

The plasma gas flowing through the plasma burner 10 is directed through the arc, and is thereby ionized. The dissociation and/or subsequent ionization produce a highly heated electrically conductive gas of positive ions and electrons, namely the plasma. The plasma has a temperature of approximately 12,000° C. at a plasma gas feed rate of approximately 100 l/min. It flows through the nozzle 18 and expands along the longitudinal axis of the nozzle 18. The plasma is thereby carried to the conductive wire 14 which is continuously vertically supplied to the nozzle 18, whereby the electric circuit is closed. The arc thus produced has a temperature of approximately 4,000° C. According to the present invention, the conductive wire 14 is supplied at a feed rate of 8 to 22.5 kg/h and is resistance-heated by the large currents applied, whereby the conductive wire 14 transitions into a state in which the conductive wire 14 is molten and atomized by the impact of the plasma.

The bores 16 are surrounded by a plurality of ducts 20 through which an atomizer gas flows that is composed of an inert gas, in the present case nitrogen, and supplied at a feed rate of approximately 900 l/min. This additional gas flow creates an inert atmosphere and serves as a carrier gas for the molten particles 22 of the conductive wire 14 and provides additional atomization of molten particles 22. The gas flow spin-coats the cylinder inner wall 24 of the cylinder 26 with the molten particles 22.

The mass feed rate of the conductive wire 14 which is approximately doubled for a PTWA or RSW spraying process as well as the reduced velocity of the atomizer gas flow provide that not all molten particles 22 of the coating material 15 applied to the cylinder inner wall 24 by spin coating melt and hit the cylinder inner wall 24 to be coated at a relatively low velocity. A relatively low particle surface temperature of approximately 2,000° C. is attained due to the low velocity of the gas flow and by the inert gas used as the atomizer gas. Relatively large molten particles 22 are thus produced which are deposited at the cylinder inner wall 24, resulting in a considerable increase in the layer porosity to approximately 20%.

The use of nitrogen as the atomizer gas also creates an inert atmosphere which provides that an oxidation of the molten particles 22 is considerably reduced despite the employment of a carbon-containing steel as the coating material 15. The temperature of the molten particles 22 is thus further reduced since exothermal reactions are to a large extent prevented so that large molten particles 22 are again produced. The content of oxides 28 in the coating 30 at the cylinder inner wall 24 is thus reduced to approximately 3%, whereby a low wustite phase is present leading to a decreasing oxidation rate in the coating 30, so that corrosion is reduced. The martensite formation in the coating 30 is, however, maintained so that an adequate hardness of the coating 30 is provided.

The coating 30 is subsequently honed during another processing step to produce the desired cylinder running surface. This means that molten particles 22 are removed from the surface so that, due to the high porosity, open pores 32 with a high oil retaining volume are produced in which oil can to some extent be collected during operation of the crankcase, whereby a subsequent corrosion process is prevented.

A cylinder crankcase having a sprayed cylinder running surface is thus produced which is highly corrosion-resistant and which exhibits a very low wear rate due to a very good lubrication.

It should be appreciated that the scope of protection of the present invention is not limited to the described exemplary embodiment. Other methods for thermal spraying are also suitable to produce such a coating, wherein an unparalleled high quotient of mass feed rate of the spraying material relative to the inert gas feed rate is to be adhered to for obtaining the desired cylinder running surface. Reference should also be had to the appended claims.

What is claimed is:

1-12. (canceled)

13. A method for producing a cylinder running surface of a cylinder crankcase of an internal combustion engine, the method comprising:
thermally spraying a coating material comprising particles onto a cylinder inner wall of a cast cylinder crankcase using an inert gas as an atomizer gas so as to produce a coating,
wherein,
a mass feed rate of the coating material during the thermal spraying is 8 to 22.5 kg/h.

14. The method as recited in claim 13, wherein a feed rate of the atomizer gas during the thermal spraying is 900 to 1,500 l/min.

15. The method as recited in claim 13, wherein a feed rate of the atomizer gas during the thermal spraying is 300 to 900 l/min.

16. The method as recited in claim 13, wherein the inert gas is nitrogen or argon.

17. The method as recited in claim 13, wherein the coating material is a low-alloy carbon steel.

18. The method as recited in claim 13, wherein the thermally spraying is a plasma spraying, an arc spraying, a plasma transferred wire arc spraying, or a rotating single wire spraying.

19. The method as recited in claim 18, further comprising a plasma gas, wherein the plasma gas is an argon-hydrogen mixture or an argon-nitrogen mixture.

20. The method as recited in claim 19, wherein a hydrogen content of the argon-hydrogen mixture is 5 to 40%.

21. The method as recited in claim 19, wherein,
a surface temperature of the particles is 1,600° C. to 2,400° C.,
the arc spraying comprises an arc having an arc temperature of 3,000° C. to 6,000° C., and
the plasma gas has a plasma gas temperature of 10,000° C. to 15,000° C.

22. The method as recited in claim 19, wherein a feed rate of the plasma gas is 40 to 250 l/min.

23. The method as recited in claim 13, further comprising:
honing the coating to provide the cylinder running surface.

24. A cylinder crankcase for an internal combustion engine comprising a cylinder running surface produced by a method comprising:
thermally spraying a coating material comprising particles onto a cylinder inner wall of a cast cylinder crankcase using an inert gas as an atomizer gas so as to produce a coating,
wherein,
a mass feed rate of the coating material during the thermal spraying is 8 to 22.5 kg/h, and
the coating has a layer porosity of 4.5 to 25%, and
the coating has an oxide content of 0.5 to 5%.
